(19) United States
(12) Patent Application Publication
(10) Pub. No.: US 2005/0213350 A1
(43) Pub. Date: Sep. 29, 2005

(54) Liquid crystal display device and surface lighting device

(75) Inventors: Akimitsu Tsuda, Takarazuka-shi (JP); Satoru Takahashi, Kobe-shi (JP); Hubertina Huck, Eindhoven (NL); Kousuke Nasu, Osaka-shi (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRINICS N.V., Eindhoven (NL)

(21) Appl. No.: 10/514,419

(22) PCT Filed: May 12, 2003
(86) PCT No.: PCT/IB03/01969

§ 371 Date: Nov. 13, 2004

(30) Foreign Application Priority Data
May 17, 2002 (JP) 2002-143489

(51) Int. Cl. F21V 8/00

(52) U.S. Cl. 362/620; 362/626; 362/622

(57) ABSTRACT

To increase an amount of the light that can be used for the display efficiently in the total amount of the emitted light in the liquid crystal display device having the surface lighting device such as the front-light. The light (a) becomes the light component of the linearly polarized light by passing the retardation plate (11a). In the reflective polarizer (11b), only the light (b) that is a component of the polarization axis of the reflective polarizer (11b) passes through the reflective polarizer (11b) to enter into the end portion of the light guide (12). The light that is a component other than the component of the polarization axis of the reflective polarizer (11b) is reflected on the reflective polarizer (11b). The light reflected on the reflective polarizer (11b) changes from the linearly polarized light to the circularly polarized light by passing through the retardation plate (11a). The circularly polarized light (d) is transmitted into the light stick (10) and is reflected on the reflective film in the light stick (10). The reflected light (e) change from the circularly polarized light to the linearly polarized light by the retardation plate (11a). The linearly polarized light (f) passes through the polarization axis of the reflective polarizer (11b) to enter into the end portion of the light guide (12).

### BACKGROUND OF THE INVENTION

1. Field of the Invention

The present invention relates to the liquid crystal display device and the surface lighting device, particularly to reflective or transflective liquid crystal display device using the front-light as the surface lighting device.

2. Description of Related Art

A reflective or transflective liquid crystal display device has a liquid crystal cell including a pair of opposed substrates and a liquid crystal layer placed between these opposed substrates and has a so-called reflective mode display function that displays images using external light. The type of device is provided with a front-light, which is a surface lighting device, for supplying light from the display side of the liquid crystal cell to the liquid crystal cell in order to display the same reflective mode even when the external light is weak.

The front-light is mainly constructed of a light guide provided in substantially parallel to the display side of the liquid crystal cell and an edge light (side light) section that introduces light into the end portion of the light guide. The light from the edge light section is transmitted through the light guide and introduced into the liquid crystal cell with its propagation direction changed to the underside of the light guide opposed to the liquid crystal cell in the light guide, that is, the display side of the liquid crystal cell.

When such a front-light is used for a display device such as a cellular phone operating with a limited battery capacity, the front-light is required to maintain low power consumption. Reducing power consumption requires the effective amount of light to be increased. That is, increasing the light that can be efficiently used for the display out of the total amount of the emitted light can reduce the amount of power consumption.

The subject matter of the present invention is to increase an amount of the light that can be used for the display efficiently in all of the light emitted from the surface lighting device, by arranging the light efficiency increasing means between the light guide and the light generating means in the surface lighting device, for increasing the efficiency of the light which is emitted from the light generating means to the light guide.

### SUMMARY OF THE INVENTION

The present invention has been implemented in view of the above-described respects and it is an object of the present invention to provide a liquid crystal display device provided with a surface lighting device such as a front-light, capable of increasing an amount of the light that can be efficiently used for the display out of the total amount of the emitted light, and the surface lighting device used therewith.

The liquid crystal display device of the present invention is a liquid crystal display device including a liquid crystal cell having a reflective member and a surface lighting device for supplying the light to the liquid crystal cell, the surface lighting device comprising a light guide having a reflecting prism face and light emitting face opposed to the reflecting prism face, wherein the incident light is transmitted inside of the light guide, the transmitted light is reflected on the reflecting prism face, and the reflected light is emitted from the light emitting face to the liquid crystal cell, light generating means for generating the light for emitting to the light guide and light efficiency increasing means arranged between the light guide and the light generating means, for increasing the efficiency of the light which is emitted from the light generating means to the light guide.

Furthermore, the surface lighting device of the present invention comprises a light guide having a reflecting prism face and light emitting face opposed to the reflecting prism face, wherein the incident light is transmitted inside of the light guide, the transmitted light is reflected on the reflecting prism face, and the reflected light is emitted from the light emitting face to the liquid crystal cell, light generating means for generating the light for emitting to the light guide and light efficiency increasing means arranged between the light guide and the light generating means, for increasing the efficiency of the light which is emitted from the light generating means to the light guide.

These configurations make it possible to increase the light that can be efficiently used for the display out of the total amount of the light emitted from the light generating means and reduce electric power required to obtain the amount of light necessary for the display. As a result, these configurations can reduce power consumption of the liquid crystal display device.

According to the present invention, the light efficiency increasing means preferably has a reflective polarizer arranged in the light guide side and a retardation plate arranged between the reflective polarizer and the light generating means as well.

According to the present invention, the retardation plate is preferably arranged such that the light reflected on the reflective polarizer changes the linearly polarized light of polarization axis in the reflective polarizer.

According to the present invention, a direction of the polarization axis is preferably in parallel with a groove direction of the reflecting prism face in the light guide.

According to the present invention, the light generating means preferably has a light source, and a light guide member for transmitting the light emitted from the light source to feed the end portion of the light guide, the light guide member having an anti-dispersion shape which reduces the dispersion of the incident light from the end portion of the light guide.

According to the present invention, the light guide preferably has an anti-dispersion shape which reduces the dispersion of the incident light from the end portion of the light guide.

### BRIEF DESCRIPTION OF THE DRAWINGS

FIG. 1 is a view showing one arrangement of the liquid crystal display device according to Embodiment 1 of the present invention;

FIG. 2 is a plan view showing the liquid crystal display device according to Embodiment 1 of the present invention;

FIG. 3 is a magnified view of X portion in FIG. 2;

FIG. 4 is a view showing one arrangement of a part of the liquid crystal display device according to Embodiment 2 of the present invention; and

FIG. 5 is a view showing another arrangement of a part of the liquid crystal display device according to Embodiment 2 of the present invention.

### DESCRIPTION OF THE PREFERRED EMBODIMENT(S)

With reference now to the attached drawings, embodiments of the present invention will be explained in detail below.

(Embodiment 1)

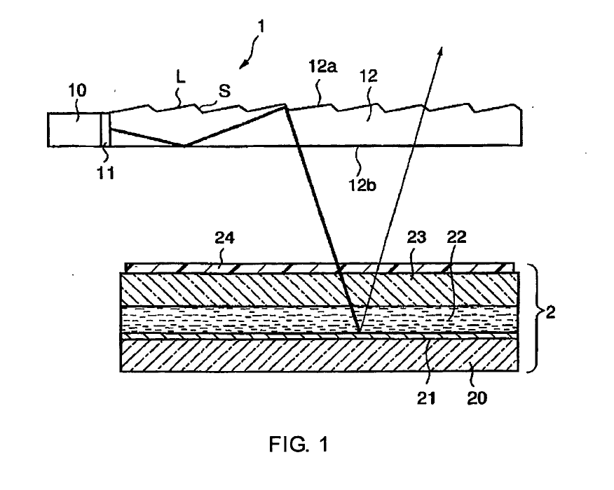

FIG. 1 is a view showing one arrangement of the liquid crystal display device according to Embodiment 1 of the present invention. Here, a case where the liquid crystal display device is a reflective liquid crystal display device will be explained. In FIG. 1, there are actually electronic elements such as an electrode and color filter, but their descriptions are omitted for simplicity of explanation.

The liquid crystal display device shown in FIG. 1 is mainly constructed of a liquid crystal cell 2 and a front-light 1, which is a surface lighting device that supplies light to the liquid crystal cell 2.

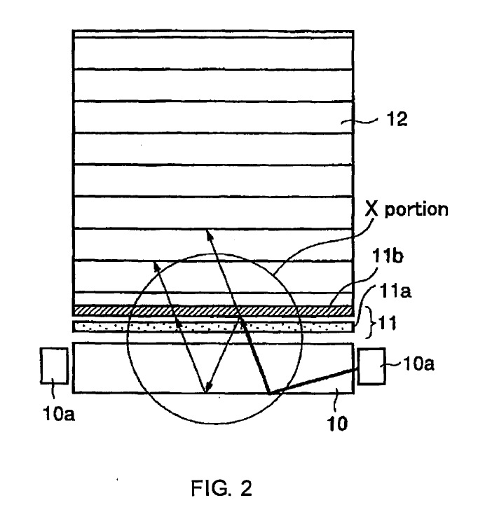

The front-light 1 is provided with a light generating member made up of an LED 10a, which is a light source, and a light stick (light guide) 10, which is a light guide member to emit the light emitted from the LED 10a to a light guide, which will be described later. As shown in FIG. 2, in the light generating member, the LED) 10a is placed on both sides of the end portions of the light stick 10. The light generating member is intended to transform light of a point light source such as the LED 10a to light of a line light source by the light stick 10 and emit the light to the end portion of the light guide. For the light generating member, any configuration other than the configuration including the LED 10a and light stick 10 is acceptable if it at least allows light of a line light source to be emitted.

A reflective film is formed on the surface of the light stick 10. The reflective film can be formed using a physical method such as sputtering. In this case, in order to supply the light from the light stick 10 to the light guide 12, it is necessary to form slits in the reflective film of the area opposed to the light guide 12.

Furthermore, the front-light has the light guide 12 having a reflecting prism face 12a on one of the main faces and a light emitting face 12b on the another main face. The light guide 12 has a shape with projections and depressions repeating alternately on the reflecting prism face 12a. In this example, the shape is formed by a combination of gentle slopes L having a relatively large area with a relatively gentle slope in a direction in which the light guide extends and steep slopes S having a relatively small area with a relatively steep slope in the direction in which the light guide extends. The longitudinal direction (groove direction) of a groove formed between the neighboring projections is designed to be substantially right angle to the direction in which the light guide 12 extends.

A light efficiency increasing member 11 for increasing the light that can be efficiently used for the display out of the total amount of the light emitted from the light generating member is arranged between the light generating member and the guide plate 12. In this embodiment, the light efficiency increasing member 11 is constructed of a reflective polarizer 11b arranged in the light guide side and a retardation plate 11a arranged between the reflective polarizer 11b and the light generating member.

Here, the absorption axis of the polarizer of the liquid crystal cell is preferably perpendicular to the groove direction of the light guide within the plane of the liquid crystal panel. That is, the vibration direction of the light that passes through the above-described polarizer is preferably parallel to the above-described groove direction This allows the amount of light that can be efficiently used for the display to be increased. In this case, the light used for the display of the liquid crystal cell is preferably only the light in the above-described vibration direction.

The liquid crystal cell 2 is mainly constructed of a pair of glass substrates 20 and 23 arranged opposed to each other and a liquid crystal layer 22 placed therebetween. A reflector 21, which is a reflective member, is provided in the area contacting the liquid crystal layer 22 on the one glass substrate 20. For the reflector 21, a metallic thin film, etc., can be used and the metallic thin film can be formed on the glass substrate 20 using a physical method such as sputtering.

A polarizer 24 is placed on the surface not contacting the liquid crystal layer 22 on the other glass substrate 23. The polarizer 24 can be arranged by pasting it onto the surface of the glass substrate 23. For the liquid crystal cell 2, a liquid crystal cell similar to that used for a reflective or transflective liquid crystal display device can be used.

The liquid crystal cell 2 in such a configuration is arranged at a predetermined distance from the front-light 1. That is, the liquid crystal cell 2 and front-light 1 are arranged such that the face of the polarizer 24 of the liquid crystal cell 2 is opposed to the light emitting face 12b of the front-light 1.

In the liquid crystal display in the above-described configuration, as shown in FIG. 2, the light emitted from the LED 10a is reflected on the reflective film of the light stick 10 inside of the light stick and emitted to the light guide 12 through the light efficiency increasing member 11.

The light from the front-light 1 enters into the end portion of the light guide 12. The light guide 12 allows the incident light to transmit inside. In this process of transmission, the light is reflected on the steep slopes S of the light guide 12 with its transmission direction drastically changed and emitted from the bottom face (light emitting face 12b) to the liquid crystal cell 2.

The light emitted from the front-light 1 passes through the polarizer 24, glass substrate 23 and liquid crystal layer 22, is reflected on the reflector 21, passes through the liquid crystal layer 22, glass substrate 23 and polarizer 24 and further passes through the light guide 12 of the front-light 1 and is emitted to the outside. In this way, a reflective mode display is performed.

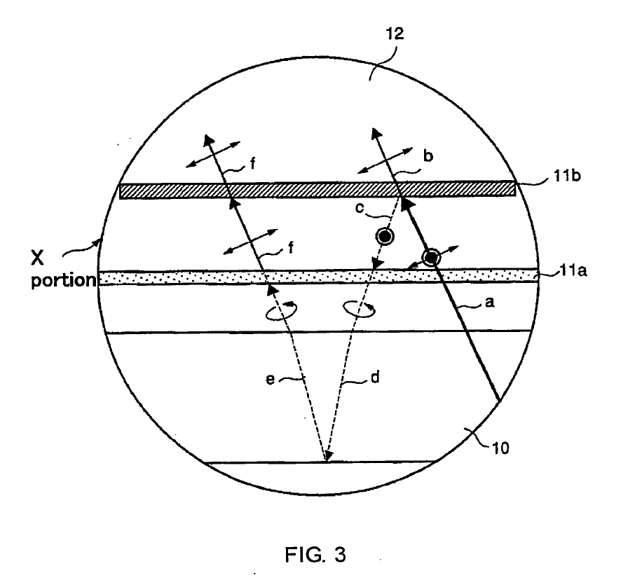

Then, the function of the light efficiency increasing member 11 of the front-light 1 will be explained. FIG. 2 is a plan view showing the liquid crystal display device according to Embodiment 1 of the present invention and FIG. 3 is a magnified view of X portion in FIG. 2.

The light emitted from the LED 11a and emitted from the light stick 10 to the light guide 12 passes through the retardation plate 11a of the light efficiency increasing member 11, further passes through the reflective polarizer 11b and enters into the end portion of the light guide 12. At this time, the reflective polarizer 11b reflects part of the light that has passed through the retardation plate 11a. The reflected light passes through the retardation plate 11a and enters into the light stick 10. The light incident upon the light stick 10 is reflected on the reflective film and passes through the retardation plate 11a, further passes through the reflective polarizer 11b and enters into the end portion of the light guide 12.

Here, the above-described function will be explained in more detail using FIG. 3.

The light a emitted from the light stick 10 includes various light components. When the light a enters into the reflective polarizer 11b, the light a is split into two polarized components; light passing through the reflective polarizer 11b and light reflected on the reflective polarizer 11b. In the FIG. 3, they correspond to a component parallel to the plane of the sheet (indicated by an arrow) and component perpendicular to the plane of the sheet (indicated by double circle including black bullet) respectively.

The light that has passed through the reflective polarizer 11b is polarized and the polarized light enters into the end portion of the light guide 12. The light reflected on the reflective polarizer 11b has a vibration direction opposite to the vibration direction of the light incident upon the light guide 12.

The retardation plate 11a transforms the light reflected on the reflective polarizer 11b from linearly polarized light to circularly polarized light. The light d of the circularly polarized light enters into the light stick 10 and is reflected on the reflective film. The retardation plate 11a is set such that the light e reflected on the reflective film is transformed from circularly polarized light to linearly polarized light by the retardation plate 11a.

If the polarized direction of the linearly polarized light f obtained here is the same as the polarization axis of the reflective polarizer 11b, the same linearly polarized light f obtained here transmits through the reflective polarizer 11b and enters into the end portion of the light guide 12.

Thus, the configuration according to this embodiment causes the light emitted from the light stick 10 to the light guide 12 to become the sum total of the light b and light f. Furthermore if the vibration direction of the light is the same as the vibration direction of the light effective for the display of the liquid crystal cell, the amount of light used for the display of the liquid crystal cell increases. That is, the means that the amount of light incident upon the light guide 12 has increased. Therefore, this makes it possible to increase the light that can be efficiently used for the display out of the total amount of the light emitted from the front-light 1 and thereby reduce the power for obtaining the amount of light necessary for the display. As a result, power consumption of the liquid crystal display device can be reduced.

In this case, the retardation plate 11a is preferably arranged such that the light changes the linearly polarized light of polarization axis in the reflective polarizer 11b. Thus, the optical axis of the linearly polarized light obtained after passing through the retardation plate 11a is aligned with the polarization axis of the reflective polarizer 11b, maximizing the increase of the light. However, the optical axis of the linearly polarized light need not always be aligned with the polarization axis of the reflective polarizer 11b.

Furthermore, when the polarization axis direction of the reflective polarizer 11b is parallel to the groove direction of the reflecting prism face 12a, the amount of light emitted from the light guide 12 reaches a maximum, and therefore it is desirable to arrange the reflective polarizer 11b and the light guide 12 in this way.

(Embodiment 2)

The embodiment will describe a case where it is possible to increase the light that can be efficiently used for the display out of the total amount of the light emitted from the front-light 1, reduce power to obtain the amount of light required for the display and reduce the dispersion of the incident light upon the light guide 12 to emit the light to the liquid crystal cell efficiently.

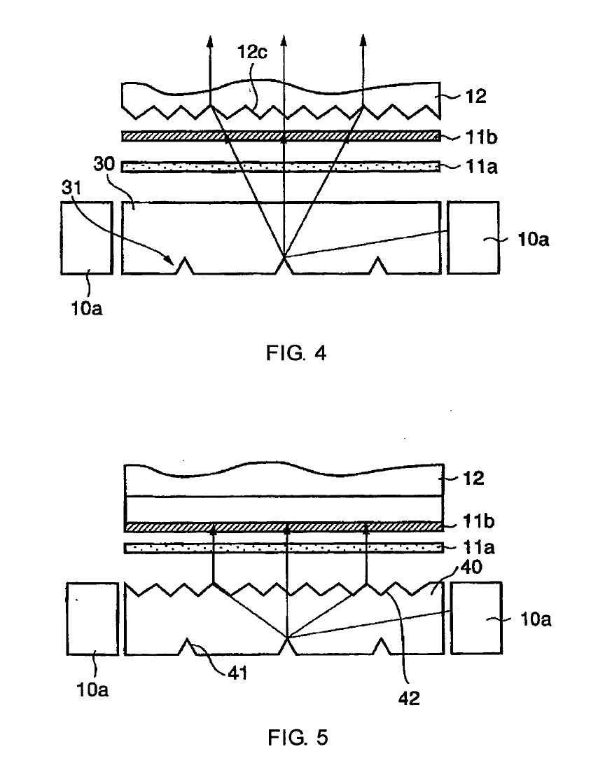

FIG. 4 is a view showing one arrangement of a part of the liquid crystal display device according to Embodiment 2 of the present invention. In FIG. 4, the same components as those in FIG. 2 are assigned the same reference numerals as those in FIG. 2 and detailed explanations thereof will be omitted.

In FIG. 4, a light stick 30 has V-shaped grooves 31 at its bottom face. The V-shaped groove 31 has the function of directing the light from the LED 10a, which is a light source, to the light guide 12. There are no particular constraints on the number and shapes of V-shaped grooves 31. Furthermore, a prism 12c having an anti-dispersion shape to reduce the dispersion of the incident light is formed on the end portion on the incident light side of the light guide 12.

The prism 12c has a concavo-convex shape, reduces the dispersion of the light incident upon the light guide 12 and preferably performs anti-dispersion so as to transform the light to parallel light. This causes the light incident upon the light guide 12 to direct to the reflecting prism face 12a, which makes the light reflected on the reflecting prism face 12a perpendicular to the light emitting face 12b allowing light to be emitted to the liquid crystal cell efficiently.

According to this configuration, the function of the light efficiency increasing member 11 is the same as that of Embodiment 1. Therefore, it is possible to increase the light that can be efficiently used for the display out of the total amount of the light emitted from the front-light 1, reduce power to obtain the amount of light required for the display and reduce the dispersion of the incident light upon the light guide 12 to emit the light to the liquid crystal cell efficiently.

FIG. 5 is a view showing another arrangement of a part of the liquid crystal display device according to Embodiment 2 of the present invention. In FIG. 5, the same components as those in FIG. 2 are assigned the same reference numerals as those in FIG. 2 and detailed explanations thereof will be omitted.

In FIG. 5, a light stick 40 has V-shaped grooves 41 at its bottom face. The V-shaped groove 41 has the function of directing the light from the LED 10a, which is a light source, to the light guide 12. There are no particular constraints on the number and shapes of V-shaped grooves 41. Furthermore, a prism 42 having an anti-dispersion shape to reduce the dispersion of the light incident upon the light guide 12 is formed on the light emitting face of the light stick 40.

The prism 42 has a concavo-convex shape, reduces the dispersion of the light incident upon the light guide 12 and preferably performs anti-dispersion so as to transform the light to parallel light. This causes the light incident upon the light guide 12 to direct to the reflecting prism face 12a, which makes the light reflected on the reflecting prism face 12a perpendicular to the light emitting face 12b allowing light to be emitted to the liquid crystal cell efficiently.

According to this configuration, the function of the light efficiency increasing member 11 is the same as that of Embodiment 1. Therefore, it is possible to increase the light that can be efficiently used for the display out of the total amount of the light emitted from the front-light 1, reduce power to obtain the amount of light required for the display and reduce the dispersion of the incident light upon the light guide 12 to emit the light to the liquid crystal cell efficiently.

The present invention is not limited to above-described Embodiments 1 and 2, but can be implemented modified in various ways. Embodiments 1 and 2 have described the case where the liquid crystal display device is a reflective liquid crystal display device, but the present invention is also applicable to a transflective liquid crystal display device having a reflective mode and transmissive mode.

Furthermore, above-described Embodiments 1 and 2 have described the case where the a reflective film is provided on the light stick 10 of the front-light 1, but the present invention is also applicable to a case where a reflective member is arranged opposed to the light guide 12 of the light stick 10.

As described above, the present invention provides light efficiency increasing means arranged between the light guide of the surface lighting device and light generating means for increasing the efficiency of light emitted from the light generating means to the light guide, and can thereby increase the light that can be efficiently used for the display out of the total amount of the light emitted from the surface lighting device.

This application is based on the Japanese Patent Application No 2002-143489 filed on May 17, 2002, entire content of which is expressly incorporated by reference herein.

1. A liquid crystal display device including a liquid crystal cell having a reflective member and a surface lighting device for supplying the light to said liquid crystal cell, said surface lighting device comprising:
a light guide having a reflecting prism face and light emitting face opposed to said reflecting prism face, wherein the incident light is transmitted inside of said light guide, the transmitted light is reflected on said reflecting prism face, and the reflected light is emitted from said light emitting face to said liquid crystal cell;
light generating means for generating the light for emitting to said light guide;
light efficiency increasing means arranged between said light guide and said light generating means, for increasing the efficiency of the light which is emitted from said light generating means to said light guide.

2. The device according to claim 1, wherein said light efficiency increasing means has a reflective polarizer arranged in the light guide side.

3. The device according to claim 2, wherein said light efficiency increasing means has a retardation plate arranged between said reflective polarizer and said light generating means.

4. The device according to claim 3, wherein said retardation plate is arranged such that the light reflected on said reflective polarizer changes the linearly polarized light of polarization axis in said reflective polarizer.

5. The device according to claim 2, wherein a direction of said polarization axis is in parallel with a groove direction of said reflecting prism face in said light guide.

6. The device according to claim 1, wherein said light generating means has a light source, and a light guide member for transmitting the light emitted from said light source to feed the end portion of said light guide, said light guide member having an anti-dispersion shape which reduces the dispersion of the incident light from the end portion of said light guide.

7. The device according to claim 1, wherein said light guide has an anti-dispersion shape which reduces the dispersion of the incident light from the end portion of said light guide.

8. A surface lighting device comprising:
a light guide having a reflecting prism face and light emitting face opposed to said reflecting prism face, wherein the incident light is transmitted inside of said light guide, the transmitted light is reflected on said reflecting prism face, and the reflected light is emitted from said light emitting face to said liquid crystal cell;
light generating means for generating the light for emitting to said light guide;
light efficiency increasing means arranged between said light guide and said light generating means, for increasing the efficiency of the light which is emitted from said light generating means to said light guide.

9. The device according to claim 8, wherein said light efficiency increasing means has a reflective polarizer arranged in the light guide side.

10. The device according to claim 9, wherein said light efficiency increasing means has a retardation plate arranged between said reflective polarizer and said light generating means.

11. The device according to claim 10, wherein said retardation plate is arranged such that the light reflected on said reflective polarizer changes the linearly polarized light of polarization axis in said reflective polarizer.

12. The device according to claim 9, wherein a direction of said polarization axis is in parallel with a groove direction of said reflecting prism face in said light guide.

13. The device according to claim 8, wherein said light generating means has a light source, and a light guide member for transmitting the light emitted from said light source to feed the end portion of said light guide, said light guide member having an anti-dispersion shape which reduces the dispersion of the incident light from the end portion of said light guide.

14. The device according to anyone of claim 8, wherein said light guide has an anti-dispersion shape which reduces the dispersion of the incident light from the end portion of said light guide.
